(19) United States
(12) Patent Application Publication
(10) Pub. No.: US 2009/0140527 A1
(43) Pub. Date: Jun. 4, 2009

(54) WIND TURBINE BLADE STIFFENERS

(75) Inventors: Ashish K. Pawar, (US); Wilfred A.A. W., (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/947,939

(22) Filed: Nov. 30, 2007

(51) Int. Cl. F03D 1/06; F03D 1/00; F03D 9/00

(52) U.S. Cl. 290/55; 416/226

(57) ABSTRACT

A blade for a wind turbine, includes a shell; a spar member for supporting the shell; and a stiffener, secured to an inside surface of the shell, for enhancing a buckling resistance of the blade.

### BACKGROUND OF THE INVENTION

1. Technical Field

The subject matter described here generally relates to fluid reaction surfaces with specific blade structures that are formed with a main spar, and, more particularly, to wind turbine blade spars with stringers.

2. Related Art

A wind turbine is a machine for converting the kinetic energy in wind into mechanical energy. If that mechanical energy is used directly by machinery, such as to pump water or to grind wheat, then the wind turbine may be referred to as a windmill. Similarly, if the mechanical energy is further transformed into electrical energy, then the turbine may be referred to as a wind generator or wind power plant.

Wind turbines use one or more airfoils in the form of a “blade” to generate lift and capture momentum from moving air that is then imparted to a rotor. Each blade is typically secured at its “root” end, and then “spans” radially “outboard” to a free, “tip” end. The front, or “leading edge,” of the blade connects the forward-most points of the blade that first contact the air. The rear, or “trailing edge,” of the blade is where airflow that has been separated by the leading edge rejoins after passing over the suction and pressure surfaces of the blade. A “chord line” connects the leading and trailing edges of the blade in the direction of the typical airflow across the blade. The length of the chord line is simply the “chord.”

Wind turbines are typically categorized according to the vertical or horizontal axis about which the blades rotate. One so-called “horizontal-axis wind generator” is schematically illustrated in FIG. 1 and available from GE Energy of Atlanta, Ga. USA. This particular configuration for a wind turbine 2 includes a tower 4 supporting a drive train 6 with a rotor 8 that is covered by a protective enclosure referred to as a “nacelle.” The blades 10 are arranged at one end of the rotor 8, outside the nacelle, for driving a gearbox 12 that is connected to an electrical generator 14 at the other end of the drive train 6 along with a control system 16.

As illustrated in the cross-section for the blade 10 shown in FIG. 2, wind turbine blades are typically configured with one or more “spar” members 20 extending spanwise inside of the shell 30 for carrying most of the weight and aerodynamic forces on the blade. The spars 20 are typically configured as I-shaped beams having a web 22, referred to as a “shear web,” extending between two flanges 24, referred to as “caps” or “spar caps.” However, other spar configurations may also be used including, but not limited to “C-,” “L-,” “T-,” “X-,” “K-,” and/or box-shaped beams. The spar caps 24 are typically secured to the inside surface of the shell 30 that forms the suction and pressure surfaces of the blade. In configurations, the spar caps 24 form part of the inside surface of the shell 30. The spar 20 may also be utilized without caps 24 and/or the web 22 may be formed integrally with other portions of the blade 10, including the shell 30.

Modern wind turbine blades 10 have become so large that, even with the structural features described above, they can still suffer from buckling failure at stresses that are smaller than the ultimate strength of materials from which they are constructed. For example, so-called “self buckling” can occur where the vertical length of the blade 10 exceeds a certain critical height, while “dynamic buckling” can occur for even smaller loads that are suddenly applied to the blade, and then released. It is well known that the buckling resistance of a columnar structure can generally be increased, without increasing its weight, by distributing the material in the structure as far as possible from the principle axes of its cross section so as to increase its moment of inertia. However, the profile of the blade 10 is controlled by aerodynamic, rather than structural, considerations. Furthermore, current manufacturing techniques for wind turbine blades 10 also generally require a core over which a skin material can be draped in order to form the contour of the airfoil. And, due to the large surface area of the blade 10, even small increases in the overall skin thickness can lead to undesirable increases in the weight of the blade 10.

### BRIEF DESCRIPTION OF THE INVENTION

These and other aspects of such conventional approaches are addressed here by providing, in various embodiments, a blade for a wind turbine including a shell; a spar member for supporting the shell; and a stiffener, secured to an inside surface of the shell, for enhancing a buckling resistance of the blade.

### BRIEF DESCRIPTION OF THE DRAWINGS

Various aspects of this technology invention will now be described with reference to the following figures (“FIGs.”) which are not necessarily drawn to scale, but use the same reference numerals to designate corresponding parts throughout each of the several views.

FIG. 1 is a schematic side view of a conventional wind turbine.

FIG. 2 is a schematic, cross-sectional view of the blade taken along chord section line II-II in FIG. 1.

FIG. 3 is a schematic, cross-sectional view of another wind turbine blade.

FIG. 4 is a schematic partial cross-section of a blade taken along chord section line IV-IV shown in FIG. 3.

FIG. 5 is an enlarged partial cross-section of the blade shown in FIG. 3.

FIG. 6 is a schematic, partial orthographic view of a wind turbine blade.

FIG. 7 is another schematic, partial orthographic view of a wind turbine blade.

FIG. 8 is yet another schematic, partial orthographic view of a wind turbine blade.

FIG. 9 is a schematic partial cross-section of a blade taken along chord section line IX-IX shown in FIG. 3.

### DETAILED DESCRIPTION OF THE INVENTION

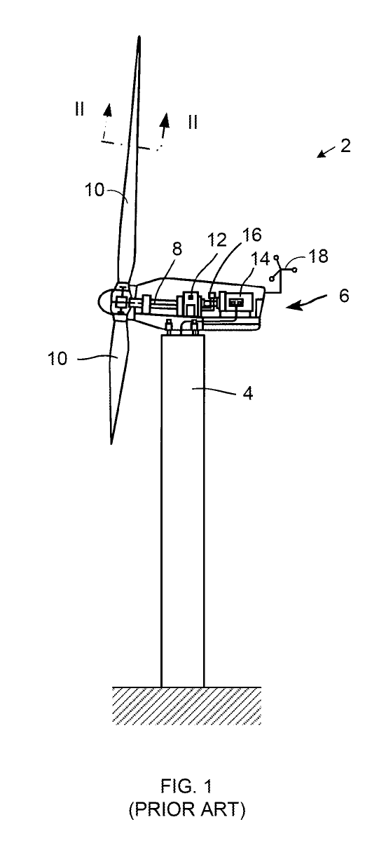

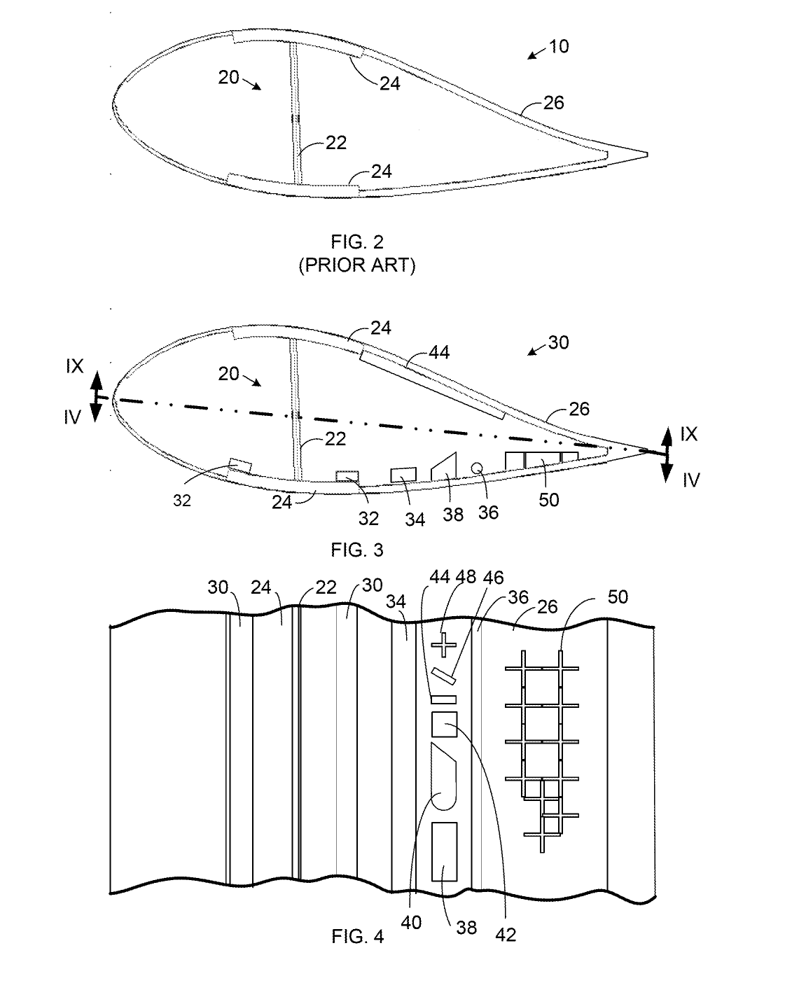

FIG. 3 is a schematic, cross-sectional view of a wind turbine blade 30 for use with the wind generator 2 shown in FIG. 1 and/or any other suitable wind turbine. For example, the blade 10 shown in FIGS. 1 and 2 may be replaced with the blade 30 and/or modified to include any of the features of the various configurations of the blades 30 illustrated in FIGS. 3-7, and/or combinations of those features.

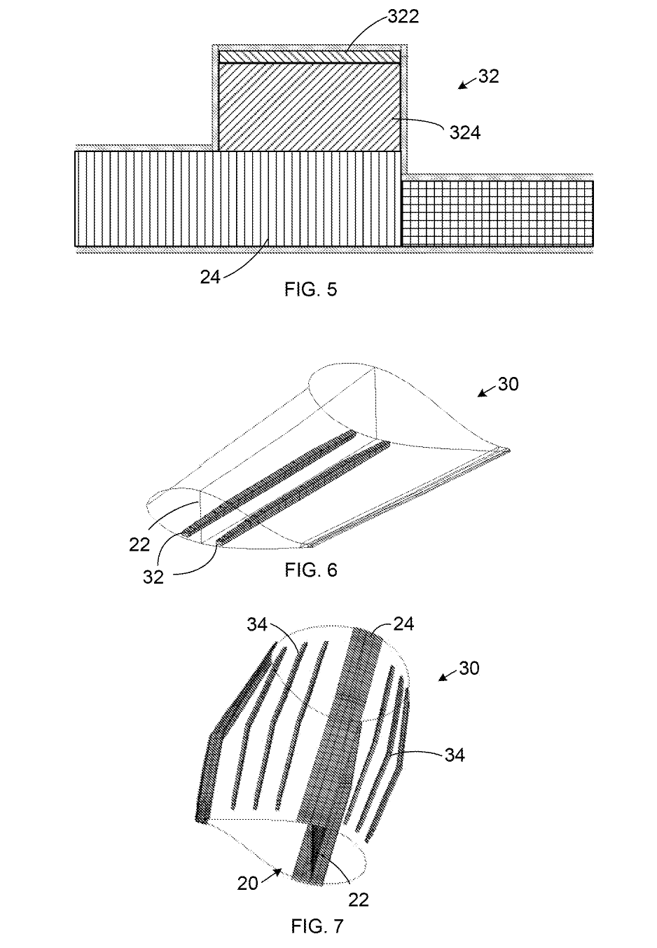

FIGS. 3-7 illustrate various structures corresponding to means for enhancing the buckling resistance of the blade 30. For example, in FIG. 3, stiffener strips 32 through 50 are secured to an inside surface of the shell 26. In particular, the flange strips 32 are long, thin, and narrow structures that are secured to the flange 24. As illustrated in the enlarged, schematic partial cross section of FIG. 5, one or both of the flange strips 32 may include various layers such as a crown skin layer 322 and/or a core layer 324, where the core layer and/or skin layer may be formed from materials including, but not limited to, balsa wood, foam, and reinforced composites such as glass reinforced plastic. The core layer 324 may also be hollowed in order to further reduce weight.

Buckling factor analysis for various configurations suggests that continuous strips, with a 50 millimeter by 25 millimeter rectangular, cross sections may provide the greatest enhancement for the least increase in weight. However, other configurations may also be used including, but not limited to, 75×75, 75×50, and 50×50 millimeter dimensions, and/or non-rectangular, discontinuous, and transverse stiffeners that are not necessarily arranged on the flange 24.

Alternatively, or in addition to flange strips 32, a continuous stiffener 34 may be arranged to extend spanwise across the blade 30 and secured to the shell 26 at a position which is displaced from the flange 24. Stiffeners with non-rectangular cross-sections may also be used, such as the round stiffener 36 shown in FIG. 3 and/or elliptical stiffeners, triangular stiffeners, pentagonal stiffeners, and so on. The stiffeners do not necessarily need to extend across the entire span of the blade 30. For example, the stiffener 38 extends only part way across the span of the blade 30) and has an angled top surface resulting in one of many possible variations on a non-rectangular cross section. Various end configurations may also be provided for the stiffeners. For example, the stiffener 40 has one rounded end and one angled end.

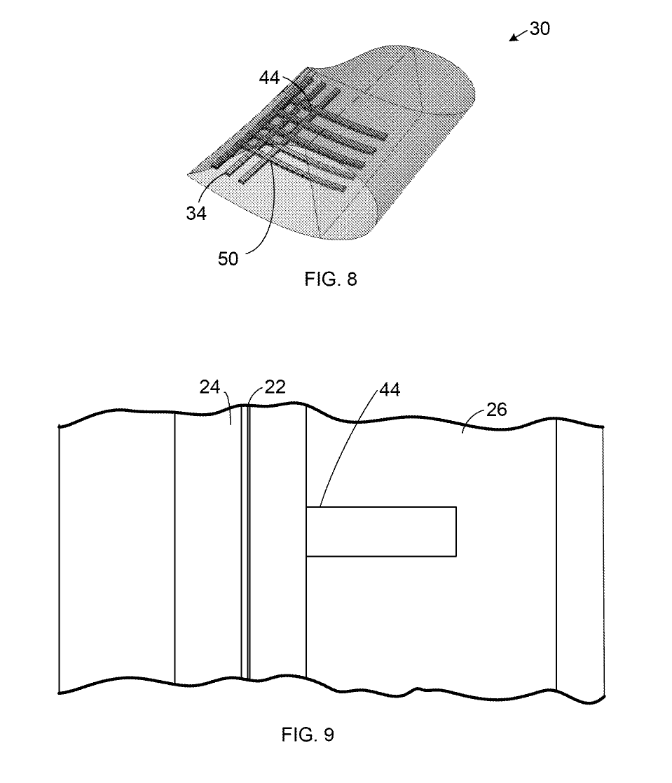

The stiffener 42 illustrates a square plan configuration which extends equal distances in both the chordwise (or “cross”) and spanwise directions of the blade 30. However, other plan configurations may also be used including elliptical, circular, triangular, pentagonal, and etc. A transverse rectangular stiffener strip 44 extends substantially chordwise across the blade 30 in FIGS. 4 and 9, while the angled stiffener strip 46 extends substantially chordwise and spanwise across the blade 30. Other configurations that extend both substantially chordwise and spanwise across the blade 30 include the cross stiffener 48 and the grid stiffeners 50 shown in FIGS. 4 and 8.

The stiffeners are not necessarily required to have the same thickness across the span and/or chord of the blade 30. For example, FIG. 6 illustrates another pair of flange strips 32 that are thickened in the central regions where buckling resistance needs to be enhanced the most. FIG. 7 illustrates other stiffeners 34 having variable cross-sections along the span of the blade 30. The grid stiffeners 50 may also have variable width, thicknesses, and/or spacings between members.

The various stiffeners may also be arranged at other locations in the blade 30 than shown and described here. In fact, the buckling resistance of the blade 30 may be significantly enhanced by arranging the stiffeners in areas of the blade with the longest chord. As illustrated in FIG. 8, a grid stiffener 50 may be arranged with one or more spanwise rectangular stiffener strips 34 arranged substantially parallel to the trailing edge of the blade 30. Additional transverse strips 44 are then arranged to extend chordwise from the outermost of the strips 34 to the edge of the flange 24 (not shown in FIG. 8). Various spacings may be provided between the stiffener strips 34 and transverse strips 44 that form the grid stiffener 50 illustrated in FIG. 8. For example, the spacing may be about the width of one to two stiffener strips.

The various embodiments described above provide enhanced buckling resistance for wind turbine blades. It should be emphasized that the embodiments described above, and particularly any “preferred” embodiments, are merely examples of various implementations that have been set forth here to provide a clear understanding of various aspects of this technology. It will be possible to alter many of these embodiments without substantially departing from scope of protection defined solely by the proper construction of the following claims.

What is claimed is:

1. A blade for a wind turbine, comprising:
a shell;
a spar member for supporting the shell; and
a stiffener, secured to an inside surface of the shell, for enhancing a buckling resistance of the blade.

2. The blade recited in claim 1, wherein the stiffener comprises a strip extending substantially spanwise along the blade.

3. The blade recited in claim 1, wherein the stiffener comprises a strip extending substantially chordwise along the blade.

4. The blade recited in claim 2, wherein the stiffener strip also extends chordwise along the blade.

5. The blade recited in claim 1, wherein the stiffener comprises a grid of strips.

6. The blade recited in claim 2, wherein the shell comprises a flange secured to the spar member, and the stiffener strip is secured to the flange.

7. A wind generator, comprising:
a tower for supporting a drive train with a rotor;
a gearbox, connected to the rotor, for driving an electrical generator;
at least one blade, connected to the rotor, for driving the gearbox;
wherein the blade comprises:
a shell;
a spar member for supporting the shell; and
a stiffener, secured to an inside surface of the shell, for enhancing a buckling resistance of the blade.

8. The wind generator recited in claim 7, wherein the stiffener comprises a strip extending substantially spanwise along the blade.

9. The wind generator recited in claim 7, wherein the stiffener comprises a strip extending substantially chordwise along the blade.

10. The wind generator recited in claim 8, wherein the stiffener strip also extends chordwise along the blade.

11. The wind generator recited in claim 7, wherein the stiffener comprises a grid of strips.

12. The wind generator recited in claim 8 wherein the shell comprises a flange secured to the spar member, and the stiffener strip is secured to the flange.

13. A wind generator, comprising:
a tower for supporting a drive train with a rotor;
a gearbox, connected to the rotor, for driving an electrical generator;
at least one blade, connected to the rotor, for driving the gearbox;
wherein the blade comprises:
a shell;
a spar member for supporting the shell; and
means, secured to an inside surface of the shell, for enhancing a buckling resistance of the blade.

14. The wind generator recited in claim 13, wherein the means for enhancing a buckling resistance of the blade comprises a strip extending substantially spanwise along the blade.

15. The wind generator recited in claim 13, wherein the means for enhancing a buckling resistance of the blade comprises a strip extending substantially chordwise along the blade.

16. The wind generator recited in claim 14, wherein the means for enhancing a buckling resistance of the blade strip also extends chordwise along the blade.

17. The wind generator recited in claim 13, wherein the means for enhancing a buckling resistance of the blade comprises a grid of strips.

18. The wind generator recited in claim 17, wherein the grid of strips comprises
a first plurality of strips arranged substantially near and parallel to one of a trailing edge and a spar of the blade; and
a second plurality of strips extending substantially perpendicular to the first plurality of strips.

19. The wind generator recited in claim 14, wherein the shell comprises a flange secured to the spar member, and the means for enhancing a buckling resistance of the blade comprises a stiffener strip is secured to the flange.
